(19) United States
(12) Patent Application Publication
(10) Pub. No.: US 2002/0084892 A1
(43) Pub. Date: Jul. 4, 2002

(54) Remote location monitoring system

(76) Inventor: Rennie Oginni, Carrollton, TX (US)

Correspondence Address: Kaardal & Associates, PC, Attn: Ivar M. Kaardal, Suite 250, 3500 South First Ave., Sioux Falls, SD, 57105-5802, US

(21) Appl. No.: 09/751,736

(22) Filed: Dec. 29, 2000

(51) Int. Cl. B60R 25/10

(52) U.S. Cl. 340/426; 340/539

(57) ABSTRACT

A remote location monitoring system for monitoring a premises from a remote location. The remote location monitoring system includes an image capturing means for capturing an image and a sound detection means for detecting sound. A first transmitting means is provided for transmitting the images and sounds as a signal. A relaying means is provided for receiving the signal from the first transmitting means and relaying the signal. A reproduction means is provided for reproducing images and sounds represented by the signal transmitted by the first transmitting means.

### BACKGROUND OF THE INVENTION

1. Field of the Invention The present invention relates to remote location monitoring systems and more particularly pertains to a new remote location monitoring system for monitoring a premises from a remote location using a compact and easily transportable station.

2. Description of the Prior Art The use of remote location monitoring systems is known in the prior art. More specifically, remote location monitoring systems heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. No. 5,714,932; U.S. Pat. No. 4,814,751; U.S. Pat. No. 5,331,549; U.S. Pat. No. 5,828,306; U.S. Pat. No. 5,596,313; U.S. Pat. No. 4,160,875; and U.S. Pat. No. Des. 297,220.

While these devices fulfill their respective, particular objectives and requirements, the aforementioned patents do not disclose a new remote location monitoring system. The inventive device includes an image capturing means for capturing an image and a sound detection means for detecting sound. A first transmitting means is provided for transmitting the images and sounds as a signal. A relaying means is provided for receiving the signal from the first transmitting means and relaying the signal. A reproduction means is provided for reproducing images and sounds represented by the signal transmitted by the first transmitting means.

In these respects, the remote location monitoring system according to the present invention substantially departs from the conventional concepts and designs of the prior art, and in so doing provides an apparatus primarily developed for the purpose of monitoring a premises from a remote location using a compact and easily transportable station.

### SUMMARY OF THE INVENTION

In view of the foregoing disadvantages inherent in the known types of remote location monitoring systems now present in the prior art, the present invention provides a new remote location monitoring system construction wherein the same can be utilized for monitoring a premises from a remote location using a compact and easily transportable station.

The general purpose of the present invention, which will be described subsequently in greater detail, is to provide a new remote location monitoring system apparatus and method which has many of the advantages of the remote location monitoring systems mentioned heretofore and many novel features that result in a new remote location monitoring system which is not anticipated, rendered obvious, suggested, or even implied by any of the prior art remote location monitoring systems, either alone or in any combination thereof.

To attain this, the present invention generally comprises an image capturing means for capturing an image and a sound detection means for detecting sound. A first transmitting means is provided for transmitting the images and sounds as a signal. A relaying means is provided for receiving the signal from the first transmitting means and relaying the signal. A reproduction means is provided for reproducing images and sounds represented by the signal transmitted by the first transmitting means.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new remote location monitoring system apparatus and method which has many of the advantages of the remote location monitoring systems mentioned heretofore and many novel features that result in a new remote location monitoring system which is not anticipated, rendered obvious, suggested, or even implied by any of the prior art remote location monitoring systems, either alone or in any combination thereof.

It is another object of the present invention to provide a new remote location monitoring system which may be easily and efficiently manufactured and marketed.

It is a further object of the present invention to provide a new remote location monitoring system which is of a durable and reliable construction.

An even further object of the present invention is to provide a new remote location monitoring system which is susceptible of a low cost of manufacture with regard to both materials and labor, and which accordingly is then susceptible of low prices of sale to the consuming public, thereby making such remote location monitoring system economically available to the buying public.

Still yet another object of the present invention is to provide a new remote location monitoring system which provides in the apparatuses and methods of the prior art some of the advantages thereof, while simultaneously overcoming some of the disadvantages normally associated therewith.

Still another object of the present invention is to provide a new remote location monitoring system for monitoring a premises from a remote location using a compact and easily transportable station.

Yet another object of the present invention is to provide a new remote location monitoring system which includes an image capturing means for capturing an image and a sound detection means for detecting sound. A first transmitting means is provided for transmitting the images and sounds as a signal. A relaying means is provided for receiving the signal from the first transmitting means and relaying the signal. A reproduction means is provided for reproducing images and sounds represented by the signal transmitted by the first transmitting means.

Still yet another object of the present invention is to provide a new remote location monitoring system that reduces anxiety experienced by travelers about the safety of their belongings and loved ones by allowing travelers a means of remotely monitoring a location such as their home.

Even still another object of the present invention is to provide a new remote location monitoring system that allows closer supervision of individuals, like children, being left home. The present invention allows parents to monitor their children's activities while they are away from home.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic perspective view of one aspect of a new remote location monitoring system according to the present invention, namely a camera having a microphone built into the camera.

FIG. 2 is a schematic perspective view of another aspect of the present invention, namely a relying means for relaying a signal from a transmitter to a reproducing means.

FIG. 3 is a schematic perspective view of yet another aspect of the present invention, namely a reproducing means used for monitoring a remote location.

FIG. 4 is a schematic diagram of the present invention.

### DESCRIPTION OF THE PREFERRED EMBODIMENT

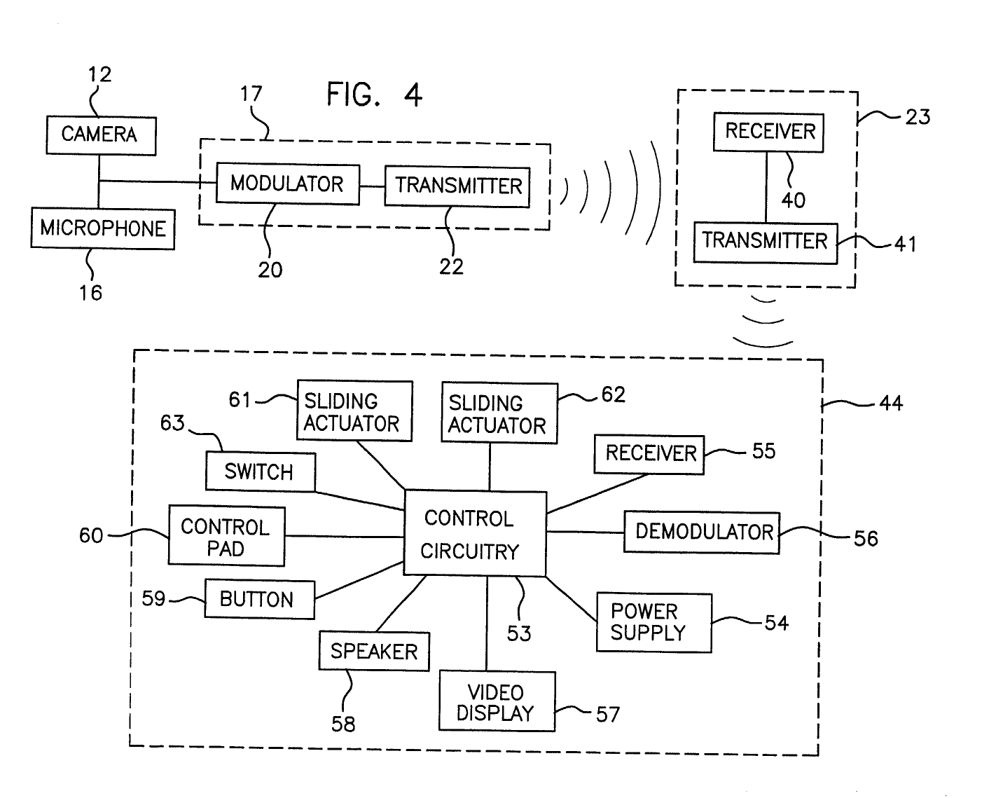

With reference now to the drawings, and in particular to FIGS. 1 through 4 thereof, a new remote location monitoring system embodying the principles and concepts of the present invention and generally designated by the reference numeral 10 will be described.

As best illustrated in FIGS. 1 through 4, the remote location monitoring system 10 generally comprises an image capturing means for capturing an image. A first transmitting means 17 is provided for transmitting the images and sounds as a signal. A relaying means is provided for relaying the signal to a reproduction means 44. The reproduction means 44 is provided for reproducing the images and sounds captured by the image capturing means.

The image capturing means may comprise at least one video camera 12 that may be included in a housing 14. The image capturing means may also include a sound detection means for detecting sound occurring in the area of the image capturing means. The sound detection means may comprise at least one microphone 16. The microphone 16 is designed for recording sounds that are emitted on the premises being monitored in the area of the microphone 16. The microphone 16 is positioned generally in the housing 14 of the video camera 12 and mounted thereto.

The first transmitting means 17 comprises a converting means for converting the images from the video camera 12 and the sounds from the microphone 16 into the signal. The converting means is electrically connected to the video camera 12 and the microphone 16. The converting means may comprise a modulator 20. A sending means for sending the signal from the converting means is electrically connected to the converting means. The sending means may comprise a transmitter 22.

In one embodiment, there may be a relaying means 23 for receiving and resending the signal from the sending means. The relaying means 23 may include a casing 24. The casing 24 includes a front wall 25, a back wall 26, a top wall 27, a bottom wall 28, and a pair of side walls 29. The casing 24 may comprise a substantially rigid material such as, for example, a metal or a plastic.

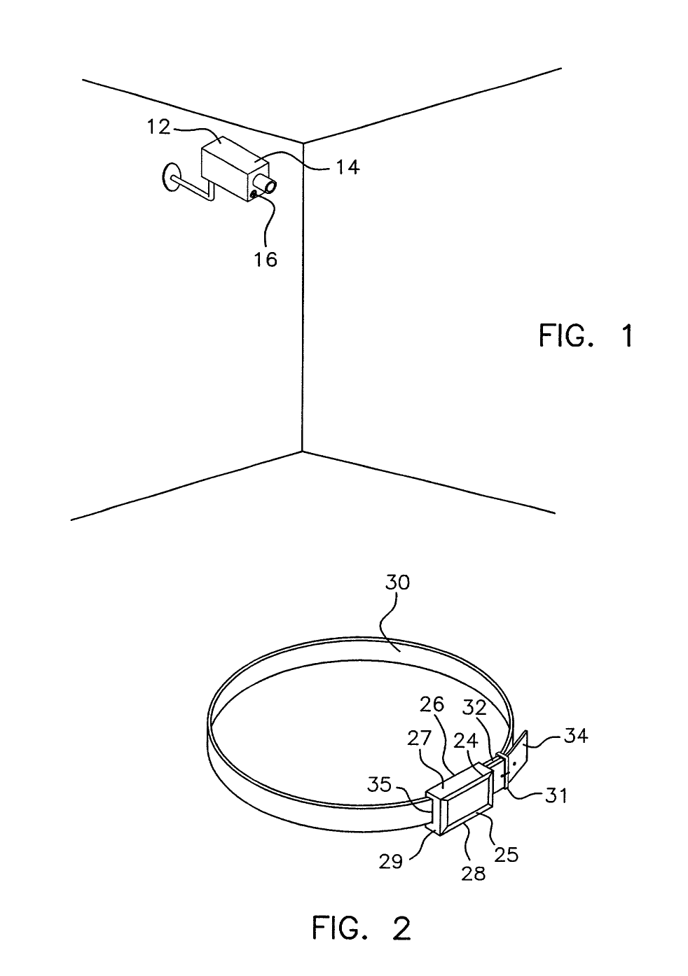

As illustrated in FIG. 2, the relaying means 23 preferably includes a securing means for securing the casing 24 to an article of clothing of the user. The securing means may comprise an elongated belt or strap 30. The elongated belt or strap 30 includes a first end 32 and a second end 34. A portion of the belt or strap is attached to one of the side walls 29 of the casing 30. The second end of the belt or strap 34 is removably inserted through a hole 35 in each of the side walls 29 of the casing 24. The second end 34 of the belt or strap 30 is releasably couplable to an intermediate location on the belt or strap 30. The belt or strap 30 may comprise a generally flexible material such as, for example, a cotton or leather material. Optionally, the casing may be adapted to be mounted on a belt of the user's clothing.

As also illustrated by FIG. 2, a fastening means 31 may be attached to the belt or strap for fastening the second end 34 of the belt or strap 30 to the intermediate location on the belt or strap 30. The fastening means 31 is positioned generally adjacent to the casing 24. The fastening means 31 may comprise a belt buckle.

The relaying means 23 preferably includes a first receiving means for receiving the signal from the transmitting means. The receiving means preferably comprises a receiver 40 mounted in the casing 24. The relaying means 23 may also include a second transmitting means for retransmitting the signal received by the first receiving means. The second transmitting means preferably comprises a transmitter 41 that is electrically connected to the first receiving means. The second transmitting means may be mounted in the casing 24.

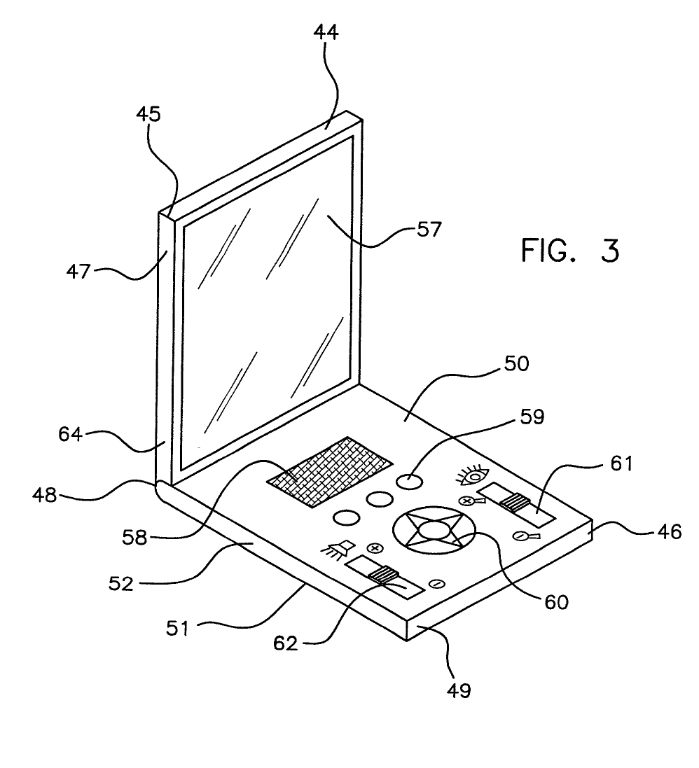

As illustrated in FIG. 3, the security system 10 includes a reproduction means 44 for reproducing images and sounds represented by the signal received by the relaying means 23. The reproduction means 44 preferably comprises a housing 45 having a first portion 46 and a second portion 47 pivotally mounted together in a clam shell fashion. The first portion 46 includes a first end 48, a second end 49, a top wall 50 and a bottom wall 51. A peripheral wall 52 is coupled to and extends between the top and bottom walls 50 and 51 of each of the portions 46 and 47. The first end 48 of the first portion 46 is pivotally mounted to an end 64 of the second portion 47.

Control circuitry 53 is provided for remotely controlling the image capturing means and the sound detection means. The control circuitry 53 may be mounted in the housing 45. The control circuitry 53 is electrically connected to a power supply 54 that is removably mounted in the housing 44.

A second receiving means is provided for receiving the signal from the relaying means 23. The second receiving means may be mounted in the first portion 46 of the housing 45 of the reproduction means 44. The second receiving means is electrically connected to the control circuitry 53. The second receiving means may comprise a receiver 55.

A converting means is provided for converting the signal received by the second receiving means to images and sounds. The converting means is electrically connected to the control circuitry 52. The converting means may be mounted in the first portion 46 of the housing 45 of the reproduction means 44. The converting means may comprise a demodulator 56.

A video display 57 is provided for displaying the images and sounds converted by the converting means. The video display 57 may be mounted in the second portion 47 of the housing 45 of the reproduction means 44. The video display 57 is electrically connected to the control circuitry 53. The video display 57 may comprise a liquid-crystal display.

A speaker 58 may be provided for emitting sounds represented by the signal. The speaker 58 may be mounted in the first portion 46 of the housing 45 of the reproduction means 44. The speaker 58 may be positioned generally adjacent to the video display 57 in the second portion 47. The speaker is electrically connected to the control circuitry 53.

A plurality of selection means is provided for selecting one of the video cameras 12 of the image capturing means if more than one video camera 12 is available. Each of the selection means is electrically connected to the control circuitry 53. Each of the selection means may be mounted in the first portion 46 of the housing 45 of the reproduction means 44 and may be positioned generally adjacent to the speaker 58. Each of the selection means may comprise a button 59.

A control means may be provided for controlling a selected one of the video cameras 12. The control means is electrically connected to the control circuitry 53. The control means may be mounted in the first portion 46 of the housing 45 of the reproduction means 44 and may be positioned generally adjacent to the selection means. The control means may comprise a control pad 60. In another embodiment, the control means may comprise a joystick.

A focusing means may be provided for focusing the selected the video camera 12 of the image capturing means. The focusing means is electrically connected to the control circuitry 53. The focusing means may be mounted on the first portion 46 of the housing 45 of the reproduction means 44. The focusing means may be positioned generally adjacent to the control means. The focusing means may comprise a sliding actuator 61.

A volume control means may be provided for controlling the volume of sounds emitted from the speaker 58. The volume control means is electrically connected to the control circuitry 53. The volume control means may be mounted in the first portion 46 of the housing 45 of the reproduction means 44 and may be positioned generally adjacent to the control means. The volume control means may comprise a sliding actuator 62.

A switch means may be provided for turning the video display 57 on and off. The switch is electrically connected to the control circuitry 53. The switch means may be mounted in the first portion 46 of the housing 45 of the reproduction means 44 and may be positioned generally adjacent to the speaker 58. The switch means may comprise a switch 63.

In use, the reproduction means 44 may be used to select at least one video camera 12 that is positioned on a premises to be monitored. By moving the control pad 60, the video camera 12 may be moved to view a larger part of the premises being monitored.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A security system for remote viewing of a premises, said system comprising:
an image capturing means for capturing an image;
a first transmitting means for transmitting the images and sounds as a signal;
a relaying means for receiving the signal from said first transmitting means and relaying the signal; and
a reproduction means for reproducing images and sounds represented by the signal transmitted by said first transmitting means.

2. The security system of claim 1, wherein said image capturing means comprises at least one video camera, a sound detection means for detecting sound, said sound detecting means comprising at least one microphone being mounted in said video camera.

3. The security system of claim 2, wherein said first transmitting means comprises a converting means for converting the images from said video camera and the sounds from said microphone into to a signal.

4. The security system of claim 3, wherein said first transmitting means comprises a sending means for sending the signal from said converting means.

5. The security system of claim 1, wherein said relaying means comprises:
a casing;
a first receiving means for receiving the signal from said first transmitting means, said receiving means being mounted in said casing; and
a second transmitting means for retransmitting the signal received by said first receiving means.

6. The security system of claim 5, additionally comprising
a securing means for securing said casing to an article of clothing.

7. The security system of claim 6, wherein said securing means comprises a strap having a first end and a second end, a portion of said strap being attached to one of a pair of side walls of said casing, said second end of said strap being removably inserted through a hole in each of said side walls of said casing, said second end of said strap being releasably couplable to an intermediate location on said strap.

8. The security system of claim 6, additionally comprising a fastening means for fastening a second end of said strap to an intermediate location on said strap.

9. The security system of claim 1, wherein said reproduction means comprises:
a housing having a first portion and a second portion pivotally mounted together in a clam shell fashion;
control circuitry for remotely controlling said image capturing means and said sound detection means;
a second receiving means mounted in said housing for receiving the signal from said relaying means
a converting means mounted in said housing for converting the signal received by said second receiving means to images and sounds, a video display being mounted in said housing for displaying the images and sounds converted by said converting means, a speaker being mounted in said housing for emitting sounds;
a power supply electrically connected to said control circuitry.

10. The security system of claim 9, additionally comprising a plurality of selection means for selecting one of said video cameras of said image capturing means.

11. The security system of claim 9, additionally comprising a control means for controlling a selected one of said video cameras.

12. The security system of claim 9, additionally comprising a focusing means for focusing the selected said video camera of said image capturing means.

13. The security system of claim 9, additionally comprising a volume control means for controlling the volume of sounds emitted from said speaker.

14. The security system of claim 9, additionally comprising a switch means for turning said video display means on and off.

15. A security system, for remote viewing of a premises, said system comprising:
an image capturing means for capturing an image, said image capturing means comprising;
at least one video cameras having a housing for recording images, said;
a sound detection means for detecting sound, said sound detection means comprising;
at least one microphone being adapted for recording a sound, said microphone being positioned generally in said housing of said video camera and mounted thereto;
a first transmitting means for transmitting the images and sounds as a signal, said transmitting means comprising;
a converting means for converting the images from said video camera and the sounds from said microphone into to the signal, said converting means being electrically connected to said video camera and said microphone, said converting means comprising a modulator;
a sending means for sending the signal from said converting means, said sending means being electrically connected to said converting means, said sending means comprising a transmitter;
a relaying means for receiving and sending the signal from said sending means, said relaying means comprising;
a casing having a front wall, a back wall, a top wall, a bottom wall, and a pair of side walls;
a securing means for securing said casing to an article of clothing, said securing means comprising an elongated strap having a first end and a second end, a portion of said strap being attached to one of said side walls of said casing, said second end of said strap being removably inserted through a hole in each of said side walls of said casing, said second end of said strap being releasably couplable to an intermediate location on said strap;
a fastening means for fastening said second end of said strap to said intermediate location on said strap, said fastening means being attached to said strap, said fastening means being positioned generally adjacent to said casing, said fastening means comprising a belt buckle;
a first receiving means for receiving the signal from said transmitting means, said receiving means being positioned in said casing, said receiving means comprising a receiver;
a second transmitting means for retransmitting the signal received by said first receiving means, said second transmitting means being mounted in said casing, said second transmitting means being electrically connected to said first receiving means, said second transmitting means comprising a transmitter;
a reproduction means for reproducing images and sounds represented by the signal received by said relaying means, said reproduction means comprising;
a housing a first portion and a second portion pivotally mounted together in a clam shell fashion, each of said portions having first end, a second end, a top wall and a bottom wall, a peripheral wall being coupled to and extending between said top and bottom wall of each of said portions, said first ends of each of said portions being pivotally mounted together;
control circuitry for remotely controlling said image capturing means and said sound detection means, said control circuitry being mounted in said housing;
a power supply electrically connected to said control circuitry;
a second receiving means for receiving the signal from said relaying means, said second receiving means being mounted in said first portion of said housing of said reproduction means, said second receiving means being electrically connected to said control circuitry, said second receiving means comprising a receiver;
a converting means for converting the signal received by said second receiving means to images and sounds, said converting means being electrically connected to said control circuitry, said converting means being mounted in said first portion of said housing of said reproduction means, said converting means comprising a demodulator;
a video display for displaying the images and sounds converted by said converting means, said video display being mounted in said second portion of said housing of said reproduction means, said video display being electrically connected to said control circuitry;
a speaker for emitting sounds, said speaker being mounted in said first portion of said housing of said reproduction means, said speaker being positioned generally adjacent to said video display in said second portion;
a plurality of selection means for selecting one of said video cameras of said image capturing means, each of said selection means being electrically connected to said control circuitry, each of said selection means being mounted in said first portion of said housing of said reproduction means and being positioned generally adjacent to said speaker, each of said selection means comprising a button;
a control means for controlling a selected one of said video cameras, said control means being electrically connected to said control circuitry, said control means being mounted in said first portion of said housing of said reproduction means and being positioned generally adjacent to said selection means, said control means comprising a control pad;
a focusing means for focusing the selected said video camera of said image capturing means, said focusing means being electrically connected to said control circuitry, said focusing means being mounted on said first portion of said housing of said reproduction means, said focusing means being positioned generally adjacent to said control means, said focusing means comprising a sliding actuator;
a volume control means for controlling the volume of sounds emitted from said speaker, said volume control means being electrically connected to said control circuitry, said volume control means being mounted in said first portion of said housing of said reproduction means and being positioned generally adjacent to said control means, said volume control means comprising a sliding actuator; and
a switch means for turning said video display means on and off, said switch means being electrically connected to said control circuitry, said switch means being mounted in said first portion of said housing of said reproduction means and being positioned generally adjacent to said speaker, said switch means comprising a switch.
